(19) United States
(12) Patent Application Publication
(10) Pub. No.: US 2009/0313123 A1
(43) Pub. Date: Dec. 17, 2009

(54) System and method to shop by brands using an internet or online portal

(76) Inventor: Mary Lou Floyd, Union City, NJ (US)

Correspondence Address: ABELMAN, FRAYNE & SCHWAB, 666 THIRD AVENUE, 10TH FLOOR, NEW YORK, NY, 10017, US

(21) Appl. No.: 12/583,316

(22) Filed: Aug. 17, 2009

Related U.S. Application Data
(63) Continuation of application No. 09/681,629, filed on May 13, 2001, now abandoned.

(51) Int. Cl. G06Q 30/00; G06F 17/30; G06F 3/048

(52) U.S. Cl. 705/14.54; 705/26; 707/3; 715/760; 707/E17.014

(57) ABSTRACT

A system and method allow a user to shop by brands using an Internet or online portal to search for and to find information on the Internet, to search for and find brand products, to search for the Internet Uniform Resource Locator (URL) addresses of businesses with the expectation of receiving a correct URL clearly displayed, in one embodiment, by itself without any other related and supported information, and to facilitate the reaching, by an online consumer, of a brand name website in fewer clicks with a greatly shortened list of search returns.

### CROSS-REFERENCE TO RELATED APPLICATIONS

This application is a continuation of U.S. application Ser. No. 09/681,629, filed on May 13, 2001.

### BACKGROUND OF THE INVENTION

1. Field of the Invention

This invention is in the field of Internet applications. Specifically, it offers a new, more satisfying and successful way for online customers to begin their shopping and buying experience on the web and for brand marketing companies to reach and satisfy those customers there.

2. Description of the Related Art

Recent internet audience research from technographics studies and Internet surveys confirms that online consumers prefer to buy direct from brand names where they feel they will get the best price and the most complete range of products. Research also shows that most consumers begin their internet shopping by seeking their favorite brand names via search engines that are not found to deliver a clean, concise, accurate or uncluttered search list.

There are numerous Uniform Resource Locators (URLs) that have the word “brand” in the name. There are a number of web sites where one will find brand name merchandise. None of these alternatives accommodate all the brand names or even 50% of them—in a particular product category. In most cases a brand name appears only if that company has struck a marketing deal with the search engine or commerce web site. More research indicates that 56% of catalogue searches on business to consumer online retail sites fail—and 93% on business to business e-commerce sites—because these searches usually turn up extraneous results that are too lengthy and tedious to sort through. Therefore, consumers need an easy way to be reminded of and to find brand name web sites for their online shopping pleasure.

### BRIEF SUMMARY OF THE INVENTION

With the internet/web application of the present invention, customers don't have to know or guess at a brand company's URL until they get it right. They also don't need to hunt through the numerous listings returned by a search engine that may or just as likely may not include the correct URL. Also, with this application, brand companies don't have to register and buy multiple URLs to ensure their customers can find them on the web; be concerned with customers misspelling their company name or not remembering it altogether and pay competitive prices to buy URLs with their company name that could be owned by someone else. This brand and product search engine would eliminate all these problems because customers wouldn't have to make more than one attempt to find a brand web site and brand companies wouldn't have to spend as much money as they do today purchasing multiple URLs and expensive drive to web campaigns.

The present invention is a unique Internet search engine and marketing model. Specifically, a customer accesses or is delivered a web page with her computer or other online devise. She either types or inputs in some way onto that web page 1) a brand name and 2) a product category (optional) and is returned a page with a company's URL address and link to the actual brand site. In its most basic terms this web application is an exclusive but all inclusive search engine for the top infinite number of brand name companies. It can also be thought of as a brand cybermall where customers can find the brand company they want to shop and be navigated to their front door. It is not an online transactional commerce site itself, but rather it delivers shoppers to the brand name commerce site where the actual purchase would transpire.

### BRIEF DESCRIPTION OF THE SEVERAL VIEWS OF THE DRAWINGS

Preferred embodiments of the invention are disclosed hereinbelow with reference to the drawings, wherein:

FIG. 1 is a schematic of the system of the present invention; and

FIG. 2 is a flowchart illustrating the method of operation of the present invention.

### DETAILED DESCRIPTION OF THE INVENTION

The primary objective of this invention is to inform the end-user of a brand company's URL, although other compelling value added benefits will be explored and offered later on after the initial introduction of the service. This is a request for a patent for a unique Internet search engine and marketing model. Specifically, a customer accesses or is delivered a web page with her computer or other online devise. She either types or inputs in some way onto that web page 1) a brand name and 2) a product category (optional) and is returned a page with a company's URL address and link to the actual brand site. In essence this returned page acts like a jump page to the company's homepage. In its most basic terms this web application is an exclusive but all inclusive search engine for all the top infinite number of brand name companies. It can also be thought of as a brand cybermall where customers can find the brand company they want to shop and be navigated to their front door. It is not an online transactional commerce site itself, but rather it delivers shoppers to the brand name commerce site where the actual purchase would transpire.

Consumers can also enter a product category by itself in return for a list of brand names and URLs that offer that particular product line. Regardless of the business models outlined below, it's important that all the most well known brands in each category be searchable. One of the unique advantages of this concept is that consumers should feel that they can find any brand's URL and that their search not be dependent on advertising or sales arrangements.

Other useful company information can also be served with the URL on a jump page or an “Enhanced URL Page.” This page presents more frequently requested basic information—special promotions, store locations, store hours, phone numbers, current sales, etc.—the types of things consumers would normally want to know right away when in a shopping mode. More research will be conducted to better define these needs so as to better advise brand companies who choose to take advantage of this added feature.

What is being proposed here is a simple yet new and unique alternate approach to initiate online shopping for consumers and consumer brand companies. This concept is easily expanded to a business-to-business commerce scenario as well. While there are numerous web sites that provide e-commerce with a focus on brands, none of them have been designed or developed in a manner that more intuitively reflects and duplicates how a customer generally prefers to shop, i.e., starting with brand names they know and trust.

This service is accessible through a predetermined URL and associated website. Depending on the business model, consumers could be served by the site from a sponsor's web presence as well. As an added convenience for frequent web shoppers, it can also be reached by installing an icon right onto the consumer's desktop.

This innovative proposal translates this preferred brand shopping experience to the Internet and starts to deliver what some of the basic research is telling us online audiences want. It's based on two premises: Premise 1) Technographics research shows that consumers begin their internet shopping trips at search engine sites, where they seek out a particular brand or product. Since this is the first step in building an experiential brand for the end-user, the company's web site or URL must appear and without any other competing, compromising or distracting data if this brand experience is to be initiated on a positive note. However, returned search lists are long and delivered with other extraneous information that take users time to read through to find what they want.

The presence of popular and familiar brand names are instrumental in increasing the selling power of the Internet. Consumers in general have established a certain comfort level with these companies that cannot afford to be adversely effected with their online experience. The brand's attributes must be reflected from the moment the user thinks of the name, enters it in a search box and reviews the returned search page. Brand companies can't control this task and because a consumer's initial online experience is critical to sustaining their comfort level with the brand, successful and positive brand impressions are repeatedly and totally abandoned on the web every day as a result.

What if a consumer can't think of the brand name when beginning their search? If the brand hasn't partnered with that portal/search engine, your customer will be delivered a list of competitors. In both cases brand companies can lose their customers before they've even arrived at their site.

Premise 2) Consumers expect manufacturing brands to sell direct over the Internet even if they've never sold direct before. They assume brand sites are the best place to shop for and purchase products at the lowest price. This is because supply & demand is more instantaneous and therefore becomes more apparent on the web, which the premise for many e-commerce sites. Prices fall naturally to the lowest competitive point and vary more as demand shifts.

This concept of Dynamic Trade offers greater benefits to direct sellers than indirect ones on the Internet. The direct sellers who build their online business around intangible assets, such as customer base and technology infrastructure, will reap the greatest rewards. This is the key to creating economies of scale. As a result physical distributors will be more important to brand manufacturers as sales through retail stores are replaced in part by direct sales over the Internet. Because consumers look for the products first at foremost brand sites, most manufacturers are hosting their own consumers in search of products. Another reason consumers prefer to buy directly from a brand name company is because they are also attracted to web sites that offer a complete range of products. Retail web sites and online malls who must achieve a certain scale in order to be competitive sell brand products but normally never a brand's entire product line. Brand companies wanting to increase their reach on the Internet can negotiate a deal with one of these shopping web sites or malls whereby specific brand products are made available on the reseller's site but again never the complete inventory. In addition retail sites do not usually display the brand's image satisfactorily, compromising comfort levels as alluded to above. So if consumers look for products first at brand sites, why make them go somewhere else to buy? There are numerous working URLs that have the word “brand” in the name. There are also a number of web sites that aim to provide a shopping experience where you will find brand name merchants and merchandise. However, no other online commerce site delivers the capability of finding actual brand companies' own web sites quickly and easily within an e-commerce environment. The present invention is not a commerce engine, which means transactions are not performed on the site unlike most of these other online malls. Also, the sites referenced below only offer a specific number of brand names and a finite range of their products in limited product categories. Some of these sites provide a comparison-shopping web site that offers consumers home products only, i. e., washing machines, dryers, refrigerators, microwaves, dishwashers, cooking units, TVs, DVD players and camcorders on the website. There are plans to include other product categories including lawn and garden, small appliances, baby products, etc. Other sites act as an Internet retailer of brand name consumer products, i.e., consumer electronics, home and garden, home office, health and beauty, jewelry, gifts and more. They provide simple product search tools, many product suggestions and clearance and sale sections. They also provide customer service representatives and a 30-day return policy.

Some websites may be advertised as “the fastest way to find a great street price on a computer product.” A user can use the ‘search’ box or click through category or manufacturer lists. Dealers advertise and maintain their prices on such sites using their proprietary systems. At this time, there is a limited product category site.

Other sites have pioneered a unique new type of e-commerce with which most everyone is familiar. Consumers can use the Internet to save money on a wide range of products and services by bidding on the items. This “name your price” approach also enables sellers to generate incremental revenue. Consumer demand (in the form of individual customer offers guaranteed by a credit card) is collected for a particular product or service at a price set by the customer and communicated directly to participating sellers or to their private databases. Consumers agree to hold their offers open for a specified period of time to enable priceline.com to fulfill their offers from inventory provided by participating sellers. Once fulfilled, offers generally cannot be canceled. By requiring consumers to be flexible with respect to brands, sellers and/or product features, sellers are enabled to generate incremental revenue without disrupting their existing distribution channels or retail pricing structures. In this model, clearly brand is of the least importance.

Additional sites offer the latest computer hardware and software, the newest releases of videos and DVDs, the hottest console and PC games, chart-topping music CDs and the top selling books all at guaranteed everyday low prices. A sister site may sell closeout items at greater savings. Shoppers can purchase computers from one site and add their favorite CD from another site with all their purchases combined into one easy checkout basket. The product categories are limited to the ones stated above for the present.

Some e-commerce websites operate on a simple premise: pool the purchasing power of buyers who have a common goal of buying and receiving a discount on goods and services. Then, connect those buyers with the sellers of those products and services. Each buyer can generally benefit by achieving a lower price than would have been possible for an individual, and sellers can benefit by engaging in one large, low-cost transaction. In short, it's often a win-win for both buyers and sellers because individual buyers are able to combine their purchasing power to receive volume pricing benefits on featured merchandise. Product categories include appliances, baby products, electronics, gifts and gadgets, home and kitchen items, lawn and garden products, luggage, sporting goods, tools, and watches and jewelry. While visitors can browse and shop by consumer brands, the list of names is limited and the emphasis is on price not brand. Some sites may be comparison shopping networks and may be part of the Network Commerce Consumer Network (NCCN) featuring over 900,000 businesses and merchants in over 230 countries, and may include a leading shopping network and directory featuring over 60,000 merchants; a leading commerce-enabled entertainment community; and over 35,000 affiliate sites. NCCN is primarily a leading provider of technology infrastructure, services and networks for businesses, merchants, Internet sites, and wireless networks conducting commerce online. Some sites may provide a free online comparison shopping service that is intended to save the consumer time and money shopping on the Internet, by searching across the web for sites offering the best deals on products. It's not an online store itself but rather a site that lists deals from online stores, auctions and buying groups that match the buyer's criteria. Their goal is to help the end-user reduce their comparative shopping from days to a few minutes. The product categories are limited at this stage and again the emphasis is on price not brand.

Some of the first online shopping sites on the World Wide Web offer a wide selection of products and services from the most trusted retailers, with technologies enabling users to shop online or in their own neighborhoods. Their expanded database contains over one million products in over 8,000 different categories. Such sites have embedded cutting-edge shopping technologies, rich content, and flexible interface into a continually expanding network of high-traffic web enterprises. Through this network, a site helps destination and portal sites increase their site traffic and enhance their online communities, while placing the products and services of associated merchants within reach of millions of online shoppers. Here retailers are searched but not brands.

Another site may help consumers shop for millions of products at thousands of online stores. It's not an online store; they don't sell anything. It's not a generic search engine either; they don't simply list the names of every store on the Web. Rather they offer an unbiased service that helps shoppers decide what to buy and where to buy it. They do this by a team of helpers built with known software using technology which creates “intelligent agents” trained by a team of shopping experts to collect information from any online store instead of brand sites. Merchants aren't required to pay to be a part of the service. However, a few places around the pages are offered for advertisers with several ways to deliver their message. Their goal is to win shopper's respect as the place to start shopping online, no matter what the product. They not only compare prices but also show product availability, shipping specifications, and other useful information where possible.

The present invention provides an Internet or online portal for shoppers with a one stop shopping place for viewing and buying good quality products and services at extremely reasonable prices from reputed merchants. By providing multiple links, they encourage shoppers to spend a little time and visit different sites, compare prices and features to find the online merchant offering the most reasonable price. Their goals are to be able to generate revenues from this shopping portal, such that when you buy something through the merchants listed on the site, those merchants pass on a commission back to the site, to donate to those charities, which provide support to children.

The steps to create this service are just as simple as the service itself:

a) Recruit executive management, marketing, commerce, business development and technical development skills;

b) Research to learn more about how mainstream consumers and online laggards want to use the internet to shop;

c) Research and create a list of the top brands name companies and their product categories;

d) Evolve and sell the marketing model;

e) Design and program the search engine;

f) Develop a directory ad campaign and solicit brand name companies;

g) Develop a consumer ad campaign;

h) Design the portal web site; and

i) Develop a prototype site to use to sell concept to advertisers and consumers.

Several different business models and separate category of investors can be considered for the present invention because its easy ability to create an online community is advantageous to a number of players in the Internet space. These multiple possibilities can also complement each other and be combined in various fashions. One can be the exit strategy for the other. Below is an overview of the potential models and investors: Venture Capital (VC) Funded—This proposal can be backed in the traditional Internet business manner by securing funds from one or several venture capital investment firms. While this type of funding may be more difficult to find due to the recent failures of a number of well-known Internet businesses, some VC funders will see this business proposition's uniqueness. They'll see it as a realistic way to engage large communities of users in a more gratifying experience.

This type of funding is based on showing a profit or return on investment (ROI) within a specific timeframe. In this event the present invention can create revenue in two ways: brand advertising on the site and a percentage share (one to five percent) of each e-commerce transaction on a brand's site tracked back to the portal of the present invention. The financials have not been forecasted in this early proposal although these two revenue streams have proved positive on paper and in execution many times before. Any advertising revenue stream will need to be more inventive than the usual banner advertising, which continues to wane as a results-driven online advertising choice for brand marketers.

A unique advertising model that could prove very successful has similarities to directory advertising. Every brand gets a simple web page with their URL on it as described above. They can also elect to provide content for the “Enhanced URL Page,” a portal template page associated with the portal of the present invention that delivers other pertinent shopping information, such as store locations and departments, special events and store promotions. While there will be no initial fee for providing this additional information, later releases will offer features for brands to take advantage of via a rate card.

Established search engines could be viewed as competitors who could easily mimic this business model. However they would have to do so at the risk of alienating the online malls who are major advertisers and partners on their sites. This overall concept does not ultimately work to their advantage and in fact impacts these cybermalls in quite the opposite fashion because is promotes shopping at brand sites not cybermalls or reseller sites. It's the brand sites that can elect to link their consumers to these retail sites as part of their sales channels. This would necessitate a different pricing structure to be negotiated between these sites and the brands not associated with the portal of the present invention.

Internet Portal, Online Retail Site, ISP or ASP Owned—An Internet portal or search engine are already the beginning sites for a good majority of consumer shopping experiences. Any of these would also be logical candidates for the portal of the present invention. As previously stated, these established URL's could also present potential competition to this concept in that they could find a way to easily replicate it. They could avoid any conflict with online mall sites that are their advertisers if this innovation did not come from a third-party representative. For that matter the online malls that offer a vast range of brand products would also be an ideal funder or takeover initiator as they're already identified as a place to shop for brands.

ISPs are obvious choices to own this concept of the present invention as well. They are also already the initial starting place for millions of Internet users. The present invention helps keep their customers on their pages, which makes them stronger destination sites on the Internet.

Marketing Company Sponsored—This invention also presents a unique opportunity for a large business-to-business corporation that normally spends a huge amount of its marketing budget appealing to other large brand name companies. Their goal would not have to be to make a profit as this would not be a product line for them. Rather it could complement a service they are already selling as a value added feature. For example, a company that sells web-hosting services to a brand name company could also offer special positioning for their largest customers on the portal of the present invention as an additional selling point. While all brands need to be included in the brand database, a corporation could feature their more profitable brand clients in a special way.

Reviewing a list of corporations whose product line is targeted at most if not all major brand name companies would be a likely place to begin identifying possible candidates. Entertainment and telecommunications companies are some of the more logical opportunities. The television industry relies heavily on brand name commercial sponsorship. Telephone companies already publish directories, offline and online, that deliver company names as a result of a search effort on the part of a customer. Their advertisers could be offered premier listing on the portal of the present invention or a hot link similar to directory advertising. Directory advertising has different tiers: a regular listing, a bolded listing, a featured box, etc. These tiers could be based on the amount of revenue generated from their customer accounts.

Other hardware, software and services companies that are particularly known for their reputation in the internet space would also benefit from owning such a consumer web experience. It enhances their own identity on the web and creates a practical reason for users to come to their site thereby increasing their own traffic and marketing possibilities. They can offer their own brand name customers special treatment on this brand-focused site. As the traffic to the portal of the present invention grows, the site becomes quite valuable in terms of delivering audience numbers.

The marketing corporation could also buy this concept and/or site from its originators or a VC firm and run it for themselves. This online presence could be incorporated with their corporate web site and with an already existing legacy database of the company's customers.

The beginning link to the portal of the present invention could be positioned on the marketing company's own homepage. The success of such a useful tool would attract consumers to the marketer's site more frequently presenting the opportunity for them to build their brand image and increase their traffic on the marketing company's own corporate site. This is important as getting consumers to your website needs to be innovated again and again in many amazing and original ways. This is an answer to every corporation's current challenge of how to reinvent themselves on the Internet.

Ebusiness Consulting Company Supported—Other types of companies could benefit from owning this concept and engine are consulting and strategic planning companies. Also interactive advertising agencies and backend software development companies that have both redefined themselves as e-business strategy companies should also be considered. The Internet is the apex of an e-business. These service companies are retained by brand name clients to help them move their operations and commerce to the web. Hosting links to brand name sites, some of which these consulting companies help built, is a credible way to prove their e-commerce and e-business expertise. They would value being known as the web site to go to begin an online commerce event. It would increase their visibility in the business marketplace.

These companies also have natural brand expertise because of what they've gained from their traditional consulting work. They understand how all well know brand companies operate who are their primary bread and butter clients. Underwriting the portal of the present invention and offering it to their clients as a value add helps to support their sales premise and corporate mission.

Because anyone of these models could be successful, one can represent a way for the group creating and managing the business to be initially funded while another can be a means for the incubators to exit increasing the financial options and fallback strategies.

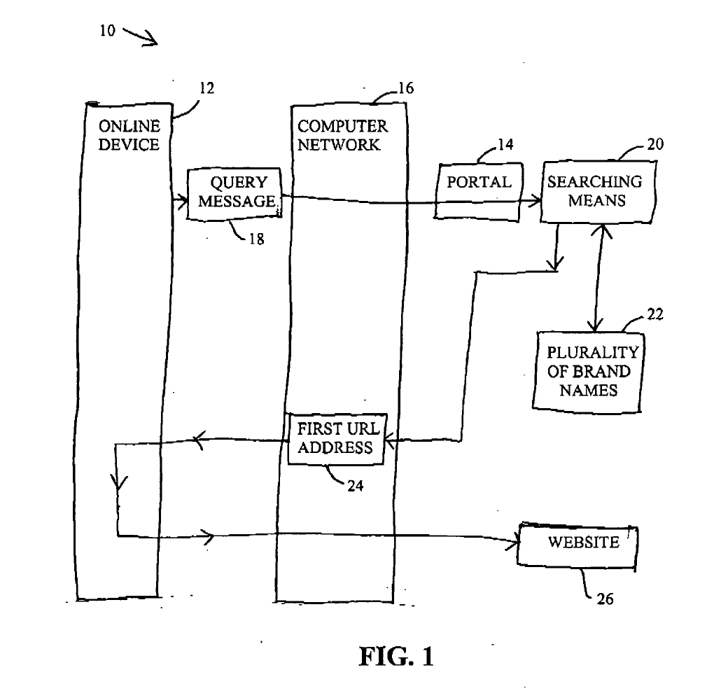

As illustrated in the schematic in FIG. 1, the present invention includes a system 10 for searching a computer network for a product associated with a brand name, with the system 10 including an online device 12 for accessing a portal 14 to a predetermined website on the computer network 16, such as the Internet or an online service, and for receiving from a user an inputted query message 18 into the online device 12, in which the query message approximates a brand name, and in which the brand name is selected from the group consisting of a company name of a desired company and a product line name of a specific product line. The system 10 also includes means 20 associated with the website for searching only a plurality 22 of brand names for a first match of the query message with a matching brand name. The online device 12 outputs a first uniform resource locator (URL) address 24 associated with the matching brand name. The online device 12, responsive to the first URL address 24, accesses an Internet-based website 26 using the first URL address 24 associated with the matching brand name. The online device 12 may be a computer and/or an interactive television.

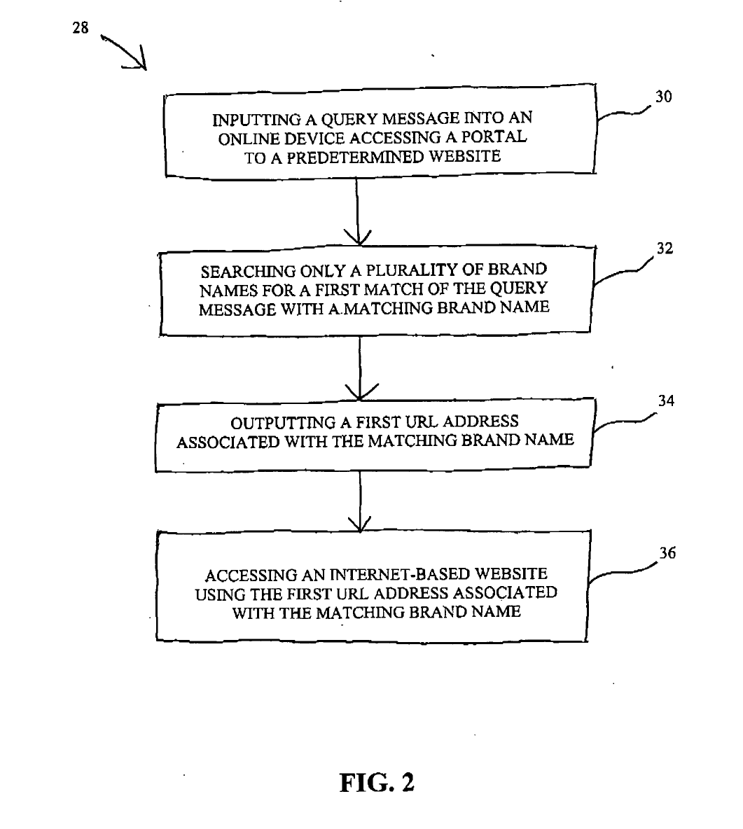

As illustrated in the flowchart in FIG. 2, the present invention also includes a method 28, using the system 10 and components thereof in FIG. 1, for searching the computer network 16 for a product associated with a brand name, with the method having the steps of: inputting in step 30 the query message 18 into the online device 12 accessing the portal 14 to the predetermined website, in which the query message approximates the brand name associated with the product, and in which the brand name is selected from the group consisting of a company name of a desired company and a product line name of a specific product line; searching in step 32 only the plurality 22 of brand names for a first match of the query message 18 with a matching brand name; and outputting in step 34 the first URL address 24 associated with the matching brand name. The method may also include the step 36 of accessing an Internet-based website using the first URL address 24 associated with the matching brand name. The method 28 may be performed using the online device 12 which includes a computer and/or an interactive television.

1. A method for searching a computer network for a product, the method comprising the steps of:
a) inputting a user-selected brand name into an online device accessing a predetermined webpage as a portal to a predetermined website;
b) searching only a plurality of brand names for a first match of the inputted user-selected brand name with a matching brand name; and
c) outputting a first uniform resource locator (URL) address of a unique webpage of the online device separate from the predetermined webpage and associated with the matching brand name which matches the inputted user-selected brand name, wherein the first URL provides information about the product corresponding to the user-selected brand name.

2. The method of claim 1, wherein the inputted user-selected brand name is selected from the group consisting of a company name of a desired company and a product line name of a specific product line.

3. The method of claim 1, wherein the online device is computer.

4. The method of claim 1, wherein the online device is an interactive television.

5. The method of claim 1, further comprising the step of:
accessing an Internet-based website using the first URL address associated with the matching brand name.

6. The method of claim 5, wherein the Internet-based website is distinct from the predetermined website associated with the portal.

7. The method of claim 5, wherein the step of accessing an Internet-based website using the first URL address includes the step of:
accessing an information webpage associated with the matching brand name.

8. The method of claim 7, wherein the information webpage displays information associated with the matching brand name, with the information being selected from the group consisting of special promotions, store locations, store hours, phone numbers, and current sales.

9. A method for searching a computer network for a product the method comprising the steps of:
a) inputting the user-selected brand name corresponding to the product into an online device accessing a predetermined webpage as a portal to a predetermined website, wherein the user-selected brand name is selected from the group consisting of a company name of a desired company and a product line name of a specific product line;
b) searching only a plurality of brand names for a first match of the inputted user-selected with a matching brand name; and
c) outputting a first uniform resource locator (URL) address of a unique webpage of the online device separate from the predetermined webpage and associated with the matching brand name which matches the inputted user-selected brand name, wherein the first URL provides information about the product corresponding to the inputted user-selected brand name.

10. The method of claim 11, further comprising the step of:
accessing an Internet-based website using the first URL address associated with the matching brand name.

11. The method of claim 11, wherein the online device is computer.

12. The method of claim 11, wherein the online device is an interactive television.

13. A system for searching a computer network for a product, the system comprising:
an online device for accessing a predetermined webpage as a portal to a predetermined website and for first receiving from a user an inputted user-selected brand name into the online device, wherein the inputted user-selected brand name is selected from the group consisting of a company name of a desired company and a product line name of a specific product line; and
means associated with the predetermined website for searching only a plurality of brand names for a first match of the inputted user-selected brand name with a matching brand name;
wherein the online device outputs a first uniform resource locator (URL) address of a unique webpage of the online device separate from the predetermined webpage and associated with the matching brand name which matches the inputted user-selected brand name, wherein the first URL provides information about the product corresponding to the inputted user-selected brand name.

14. The system of claim 13, wherein the online device, responsive to the first URL address, accesses an Internet-based website using the first URL address associated with the matching brand name.

15. The system of claim 13, wherein the online device is computer.

16. The system of claim 13, wherein the online device is an interactive television.
